(19) United States
(12) Patent Application Publication
(10) Pub. No.: US 2010/0211979 A1
(43) Pub. Date: Aug. 19, 2010

(54) CONTENT MANAGEMENT DEVICE, CONTENT REPRODUCTION METHOD, AND PROGRAM

(75) Inventors: Jin Konno, Sendai-shi (JP); Tomohide Nikaido, Sendai-shi (JP)

Correspondence Address: Seed Intellectual Property Law Group PLLC, 701 Fifth Avenue, Suite 5400, Seattle, WA, 98104, US

(73) Assignee: PANASONIC CORPORATION, Kadoma-shi, Osaka (JP)

(21) Appl. No.: 12/675,357

(22) PCT Filed: Aug. 31, 2007
(86) PCT No.: PCT/JP2007/067068

§ 371 Date: Feb. 25, 2010

(51) Int. Cl. H04N 5/445

(52) U.S. Cl. 725/59

(57) ABSTRACT

An easy-to-operate content management device, a content reproduction method and a program which do not make a user feel troublesomeness in content operation by displaying a list of contents which can be outputted by a renderer. A portable information terminal (100) comprises a device information acquisition part (104) which acquires device information on the portable information terminal (100) and device information on a device connected to a network, a content information acquisition part (106) which acquires content information on a content stored in the portable information terminal (100) and content information on a content stored in a server connected to the network, an association list information control part (105) which generates association list information obtained by associating the renderer and the content which can be reproduced by the renderer on the basis of obtained renderer information and the content information and manages the association list information, a display processing part (109) which outputs the association list information on a display screen, and a content operation control part (108) which controls content operation on the basis of the content information and device information selected from the association list information, a content operation control request and content operation information.

### TECHNICAL FIELD

The present invention relates to a content managing apparatus, content playback method and program. More particularly, the present invention relates to a content managing apparatus, content playback method and program for displaying a content list related to content stored in each server that is connected to a network.

### BACKGROUND ART

Currently, the DLNA (Digital Living Network Alliance) guideline is provided as a specification for a technique for mutually connecting, in a home network, AV devices (i.e. servers) that have server functions such as personal computers and HDD recorders that are connected to a network, and AV devices (i.e. renderers) that are content playback devices having renderer functions such as digital televisions that are outputting apparatuses, and exchanging digital content such as video images, music and photographs freely between servers and renderers.

DLNA utilizes techniques such as UPnP (Universal Plug and Play) and HTTP (Hyper Text Transfer Protocol) in combination, to enable content transferring, duplicating and playback operations by searching for server information and renderer information held by servers or by renderers and content information related to content stored by servers, and by displaying lists of content stored in the servers on the display screens of the renderers.

However, to display the list of content on a renderer and play back content, the list of content stored per server that is connected to a network is displayed, and therefore, when selecting content, users need to take inconvenience of selecting the server first, selecting the renderer next and then selecting content. Moreover, there is a problem that a conventional content list display is inconvenient because there are cases where users recognize that content is stored in another server for the first time after selecting a server.

Patent Document 1 discloses a content managing apparatus and content managing method for, when a content list is displayed, displaying content by excluding content that do not match a playback requirement, from a content list based on filter setting information. It is known that the apparatus disclosed in Patent Document 1 is configured to display a content list by excluding content that the servers cannot guarantee to play back well, from a display list based on the response speed of the servers that collectively display lists of content that exist on the network and that manage content, or the apparatus disclosed in Patent Document 1 is configured to display a content list by changing display mode of content. According to this content list display method, it is possible to collectively display a list of content that exist on the network such that the content list can easily be used.

Patent Document 2 discloses a content outputting apparatus that displays on a screen a list of content which a content playback device can play back, and that selects content from the list to play back the selected content. According to the content list display method disclosed in Patent Document 2, when the user selects content on the list, it is possible to specify a content playback device that can play back the selected content and command the specified content playback device to play back the selected content.

Patent Document 3 discloses an information processing system that determines and collects content that can be processed by a terminal provided in each information processing terminal device, based on attribute information of each information processing terminal device, and generates and displays a content information list. According to this content list display method disclosed in Patent Document 3, users perform operations looking at a content list that is displayed, so that users can perform the operations without becoming aware of in which information terminal device desired content is stored.

### Patent Document 1: Japanese Patent Application Laid-Open No. 2005-44104

### Patent Document 2: Japanese Patent Application Laid-Open No. 2006-211539

### Patent Document 3: Japanese Patent Application Laid-Open No. 2003-50589

### DISCLOSURE OF INVENTION

### Problems to be Solved by the Invention

However, there is the following problem with this conventional content playback device.

The content list display method disclosed in Patent Document 1 does not take into account the content outputting apparatus (i.e. renderer) side, and therefore, even when the servers can play back content well, if the renderer does not support playback of content, it is not possible to output content. Further, this content list display method collectively displays content, and therefore, when the servers can play back all content well, there is a problem that the number of content items in the content list becomes enormous and users feel it inconvenient to select content when they select content.

The content list display method disclosed in Patent Document 2 does not take into account the content outputting apparatus (i.e. renderer) side, and therefore, there is a problem that, even when a list of content that a content playback device can play back is displayed, if the renderer is not configured to output content, it is not possible to output content. In case where a component audio system is selected as a renderer in a home network and the like, even if a content list of moving images that the content playback device can play back is displayed, a component audio system cannot output video content.

The content list display method disclosed in Patent Document 3 displays only a list of content that a certain terminal can play back, and therefore, when a list of content that other terminals can play back needs to be displayed, there is a problem that other terminals need to perform the same content list display processing as in that certain terminal.

In view of the above, it is therefore an object of the present invention to provide a content managing apparatus, content playback method and program that provide a display of lists of content which renderers can output, and that are useful and do not make users feel inconvenient to operate content.

### Means for Solving the Problem

The content managing apparatus according to the present invention employs a configuration which includes: an input identifying section that identifies input information; a command executing section that executes a command based on a result in the input identifying section; a terminal device information managing section that manages server information and/or content playback device information; a content managing section that manages content that is held; a device information acquiring section that acquires server information held by a device connected to a network and/or content playback device information, and server information held in the terminal device information managing section and/or content playback device information, based on a device information acquisition request from the command executing section; a content information acquiring section that acquires content information of content stored in a device connected to a network and content information held in the content managing section, based on a content information acquisition request from the command executing section; an association list information controlling section that generates and manages association list information which associates content playback devices with content that the content playback devices can output, based on acquired content playback device information and content information; a display processing section that outputs the association list information to a display screen: a content operation controlling section that controls a content operation based on content information and content playback device information selected from the association list information, a content operation control request and content operation information; and a transmitting/receiving section that transmits a device information acquisition request, content information acquisition request and content operation control request, to a content playback device through a network, and that receives content playback device information, content information and content operation information from the content playback device.

The content display method according to the present invention includes the steps of: acquiring server information and/or content playback device information managed by a content managing apparatus, and server information and/or content playback device information of devices connected to a network; acquiring content information of content held in the content managing apparatus and content information of content stored in a server connected to a network; generating and managing association list information which associates content playback devices with content that the content playback devices can play back, based on acquired content device information and content information; outputting the association list information to a display screen; and controlling a content operation based on content information and content playback device information selected from the association list information, a content operation control request and content operation information.

Further, from another point of view, the present invention is a program for causing a computer to execute the above steps.

### ADVANTAGEOUS EFFECTS OF INVENTION

The present invention can provide a display of lists of content that renderers can output, by generating and displaying content lists that associate renderers with content that the renderers can play back, and can provide a display of content lists which are useful for users and do not make users feel inconvenient to operate content.

Further, the user can select content that the user wants to play back and a renderer to execute playback processing at the same time, so that it is possible to overcome inconvenience of selecting content. Furthermore, the selected renderer is able to not only play back content in servers, but also play back content in a terminal. Still further, in case where the content that is currently played back needs to be played back by switching the renderer to another renderer, it is readily possible to switch renderers.

### BRIEF DESCRIPTION OF DRAWINGS

FIG. 1 shows a configuration of a home network forming a mobile information terminal that has a content managing apparatus according to Embodiment 1 of the present invention;

FIG. 2 is a block diagram showing a configuration of a mobile information terminal that has a content managing apparatus according to above Embodiment 1;

FIG. 3 is a sequence diagram of a mobile information terminal that has a content managing apparatus and a home network formed with AV devices according to above Embodiment 1;

FIG. 4 shows an example of a screen display of association list information of a content managing apparatus according to above Embodiment 1;

FIG. 5 is a flowchart for generating association list information which associates renderers with content that the renderers can play back, in a content managing apparatus according to above Embodiment 1;

FIG. 6 is a sequence diagram of a mobile information terminal that has a content managing apparatus and a home network formed with AV devices according to Embodiment 2 of the present invention;

FIG. 7 shows an example of a screen display of association list information of a content managing apparatus according to above Embodiment 2;

FIG. 8 is a sequence diagram of a mobile information terminal that has a content managing apparatus and a home network formed with AV devices according to Embodiment 3 of the present invention;

FIG. 9 shows an example of a screen display of association list information of a content managing apparatus according to above Embodiment 3;

FIG. 10 is a sequence diagram of a mobile information terminal that has a content managing apparatus and a home network formed with AV devices according to Embodiment 4 of the present invention;

FIG. 11 shows an example of a screen display of association list information of a content managing apparatus according to above Embodiment 4;

FIG. 12 shows an example of a screen display of association list information of a content managing apparatus according to above Embodiment 4;

FIG. 13 shows an example of a screen display of association list information of a content managing apparatus according to another embodiment;

FIG. 14 shows an example of a screen display of association list information of a content managing apparatus according to another embodiment;

FIG. 15 shows an example of a screen display of association list information of a content managing apparatus according to another embodiment; and

FIG. 16 shows an example of a screen display of association list information of a content managing apparatus according to another embodiment.

### BEST MODE FOR CARRYING OUT THE INVENTION

Hereinafter, embodiments of the present invention will be explained in detail with reference to the accompanying drawings.

### Embodiment 1

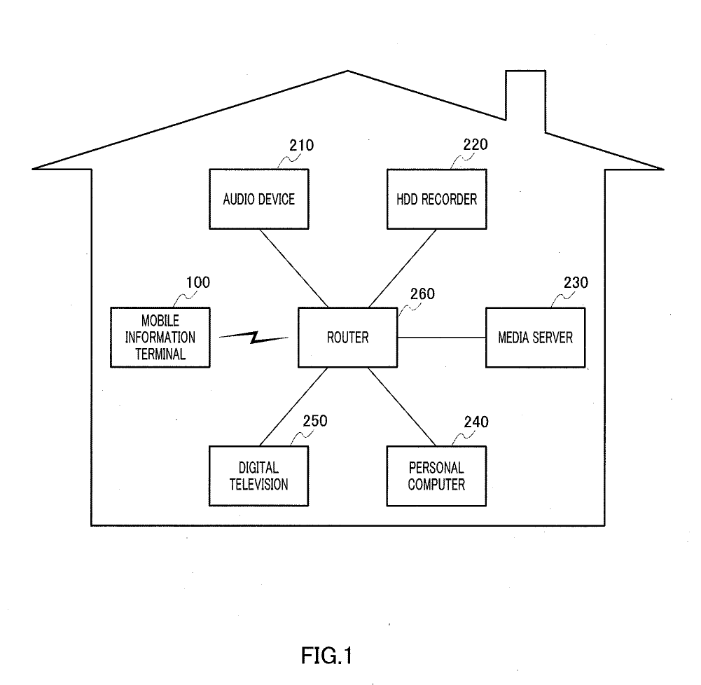

FIG. 1 shows a configuration of a home network forming a mobile information terminal that has a content managing apparatus according to Embodiment 1 of the present invention. The present embodiment is an example where a content managing apparatus and content display method are applied to a mobile information terminal and a home network formed with servers and AV devices that are connected through a network.

In FIG. 1, the home network is configured by connecting mobile information terminal 100 with AV devices 210 to 250 through router 260. Mobile information terminal 100 and router 260 are connected by wireless communication by means of, for example, wireless LAN (“WLAN” (Wireless Local Area Network)). The home network utilizes, for example, DLNA.

Mobile information terminal 100 creates association lists associating renderers with content that the renderers can play back, based on renderer information of devices connected to a network and content information of content stored in the servers, and controls a display of content lists on the screen of the mobile information terminal. To be more specific, mobile information terminal 100 displays a list of content (i.e. association list) that each renderer can play back, on a per renderer basis on the screen of mobile information terminal 100, based on the association list. Further, mobile information terminal 100 switches a display of a list of content that each selected renderer can play back, on a per selected renderer basis based on the association list. Furthermore, the content and the renderer are selected at the same time. Still further, mobile information terminal 100 can select content to be played back, and the renderer to perform playback processing, at the same time, based on the association list. Note that device information includes information about types of content that each device can play back, formats that can be played back, and codecs that allows playback. Further, content information includes information about the types of content, formats, codecs and content storage destination information.

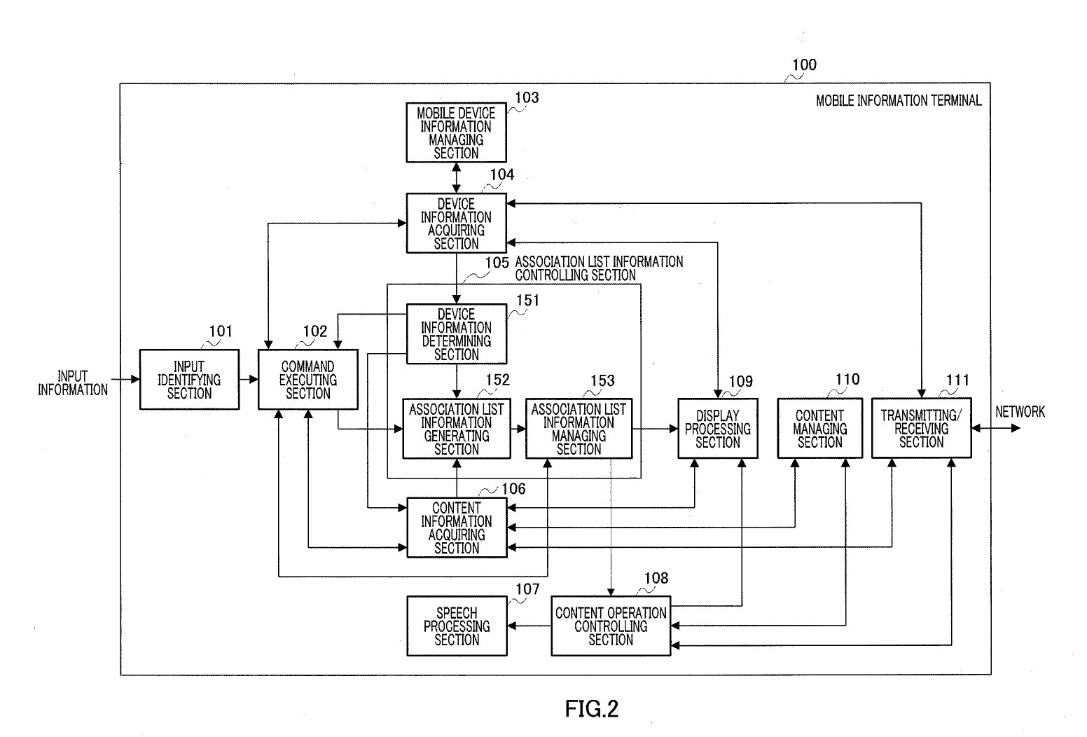

Mobile information terminal 100 is a mobile terminal apparatus such as PDA (Personal Digital Assistants) that has a wireless LAN function, and connects to router 260 to perform wireless communication. Mobile information terminal 100 is not limited to PDA as long as it is a mobile terminal that has a wireless LAN connection function, and may be a mobile terminal such as a PHS (Personal Handy-phone System)/mobile telephone. Further, wireless communication is not limited to wireless LAN, and Bluetooth (registered trademark), UWB (Ultra Wideband) and WiMAX are equally possible. Furthermore, mobile information terminal 100 may include a wireless communication terminal such as an FWA (Fixed Wireless Access) terminal that allows a move of the location where it is used. The detailed configuration of mobile information terminal 100 will be described later with reference to FIG. 2.

AV devices are audio device (AD) 210, HDD recorder 220, media server 230, personal computer (PC) 240 and digital television (TV) 250. HDD recorder 220 and media server 230 have server information as device information, and audio device (AD) 210 and digital television (TV) 250 have renderer information as device information. Mobile information terminal 100 and personal computer (PC) 240 have server information and renderer information as device information. Further, mobile information terminal 100 and each AV device support the DLNA communication standard.

FIG. 2 is a block diagram showing the configuration of mobile information terminal 100 that has a content managing apparatus.

In FIG. 2, mobile information terminal 100 employs a configuration including input identifying section 101, command executing section 102, terminal device information managing section 103, device information acquiring section 104, association list information controlling section 105, content information acquiring section 106, speech processing section 107, content operation controlling section 108, display processing section 109, content managing section 110 and transmitting/receiving section 111.

Hereinafter, the configuration of each component will be explained.

[Input Identifying Section 101]

Input identifying section 101 identifies input information.

[Command Executing Section 102]

Command executing section 102 executes a command based on the result in input identifying section 101.

Command executing section 102 outputs a content information acquisition request to content information acquiring section 106, based on a device information determination completion report from association list information controlling section 105.

Command executing section 102 outputs an association list information generation request to association list information controlling section 105, based on the content information acquisition completion report from content information acquiring section 106.

[Terminal Device Information Managing Section 103]

Terminal device information managing section 103 manages device information of mobile information terminal 100.

[Device Information Acquiring Section 104]

Device information acquiring section 104 acquires content playback device information (i.e. renderer information) held by a device connected to the network and content playback device information (i.e. renderer information) held in terminal device information managing section 103, based on the device information acquisition request from command executing section 102.

[Association List Information Controlling Section 105]

Association list information controlling section 105 generates and manages association list information that associates a content playback device (i.e. renderer) with content that the content playback device (i.e. renderer) can output, based on the acquired device information and content information.

Association list information controlling section 105 further has device information determining section 151, association list information generating section 152 and association list information managing section 153.

Device information determining section 151 determines whether the device information acquired in device information acquiring section 104 is server information and/or renderer information.

Association list information generating section 152 generates association list information that associates renderers with content that the renderers can play back, on a per renderer basis, based on the association list information generation request from command executing section 102, renderer information which is the determination result in the device information determining section and content information acquired in the content information acquiring section.

Association list information managing section 153 manages the association list information generated in association list information generating section 152, and provides the association list information to display processing section 109.

Association list information managing section 153 provides association list information matching a renderer to switch to, to display processing section 109, based on a renderer display switch request from command executing section 102.

Association list information managing section 153 provides cursor display control information for content to switch to, to display processing section 109 based on a content cursor display switch request from command executing section 102.

Association list information managing section 153 provides content information and renderer information related to the selected content, and the content operation control request from command executing section 102, to content operation controlling section 108, based on the content operation control request from command executing section 102.

[Content Information Acquiring Section 106]

Content information acquiring section 106 acquires content information of content stored in devices connected to the network and content information held in content managing section 110, based on a content information acquisition request from command executing section 102.

Content information acquiring section 106 outputs a content information acquisition request based on the content information acquisition request from command executing section 102 and the server information from association list information controlling section 105.

[Speech Processing Section 107]

Speech processing section 107 outputs speech information of the content provided from content operation controlling section 108.

[Content Operation Controlling Section 108]

Content operation controlling section 108 controls content operations based on content information selected from association list information, device information, a content operation control request and content operation information.

Content operation controlling section 108 outputs a content acquisition request to content managing section 110 based on content information and renderer information selected in association list information managing section 153, a content operation control request provided from command executing section 102 through association list information managing section 153 and content operation information managed in content operation controlling section 108, acquires content from content managing section 110 and provides the acquired content to display processing section 109 and/or speech processing section 107.

Content operation controlling section 108 outputs a content acquisition request to content managing section 110, based on content information and renderer information selected in association list information managing section 153, a content operation control request provided from command executing section 102 through association list information managing section 153 and content operation information managed in content operation controlling section 108, acquires content from content managing section 110 and outputs the acquired content and content operation control request to the selected renderer through transmitting/receiving section 111.

Content operation controlling section 108 outputs a content operation control request to the server through transmitting/receiving section 111, based on content information and renderer information selected in association list information managing section 153, a content operation control request provided from command executing section 102 through association list information managing section 153 and content operation information managed in content operation controlling section 108, acquires content stored in the server through transmitting/receiving section 111 and provides the acquired content to display processing section 109 and/or speech processing section 107.

Content operation controlling section 108 outputs a content operation control request to the server and/or renderer through transmitting/receiving section 111, such that content stored in the server is provided to the renderer based on content information and renderer information selected in association list information managing section 153, a content operation control request provided from command executing section 102 through association list information managing section 153 and content operation information managed in content operation controlling section 108.

Content operation controlling section 108 generates and manages content operation information based on a content operation control request. Content operation controlling section 108 acquires content operation information in response to the content operation control request, from the server and/or renderer connected to the network through transmitting/receiving section 111, and manages this content operation information.

[Display Processing Section 109]

Display processing section 109 outputs moving image information, still image information and/or content operation information of content provided from content operation controlling section 108, to the display screen.

Display processing section 109 outputs association list information to the display screen. To be more specific, display processing section 109 performs processing of displaying a cursor on content in association list information that is currently displayed, based on cursor display control information from association list information managing section 153, and performs processing of displaying a device information acquisition status report based on device information acquisition status report information from device information acquiring section 104. Further, display processing section 109 performs processing of displaying a content information acquisition status report based on the content information acquisition status report information from content information acquiring section 106, and performs processing of displaying content based on the content provided from content operation controlling section 108.

[Content Managing Section 110]

Content managing section 110 manages content held in mobile information terminal 100.

Content managing section 110 provides content to content operation controlling section 108 based on a content acquisition request from content operation controlling section 108.

[Transmitting/Receiving Section 111]

Transmitting/receiving section 111 transmits and receives content.

Transmitting/receiving section 111 transmits a device information acquisition request, content information acquisition request and content operation control request to a device through the network, and receives device information, content information and content operation information from the device. The acquired device information includes server information and/or renderer information.

Transmitting/receiving section 111 provides server information and renderer information received through a network, to device information acquiring section 104, and further provides content information received through the network, to content information acquiring section 106. Further, transmitting/receiving section 111 transmits content and a content operation control request to the server and/or the renderer through the network. Furthermore, transmitting/receiving section 111 receives content and content operation information from the server and/or the renderer through the network, and provides the content and content operation information to content operation controlling section 108.

As described above, the characteristics of mobile information terminal 100 include that mobile information terminal 100 has association list information controlling section 105 which performs processing of associating renderers with content that the renderers can play back, and association list information controlling section 105 creates association lists which associate renderers with content that the renderers can play back, based on renderer information and content information, and displays an association list on a per renderer basis.

The operation of mobile information terminal 100 that has a content managing apparatus configured as described above will be explained below.

A case will be explained as an example where, in a home network, when mobile information terminal 100 operates as a renderer, a server and a control point for the servers and renderers connected to the network, mobile information terminal 100 displays on its screen lists of content stored in mobile information terminal 100 and content stored in the servers that each renderer can play back, on a per renderer basis, and operates content from the displayed content list.

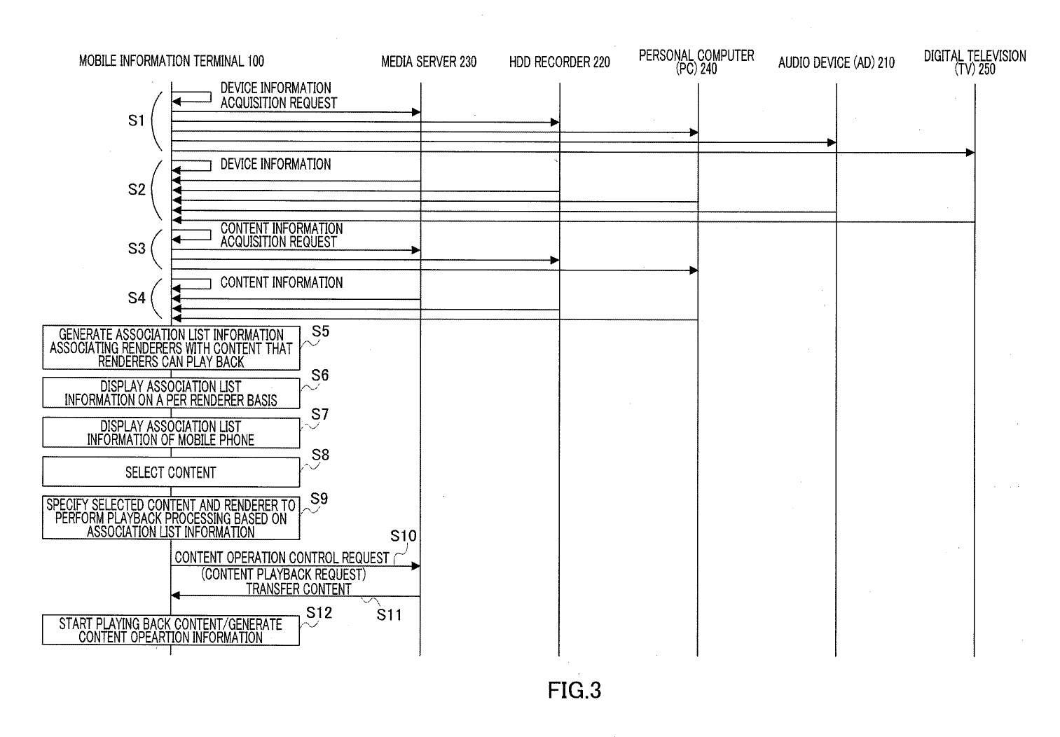

FIG. 3 is a content playback sequence diagram of mobile information terminal 100 and a home network formed with AV devices 210 to 250, and shows the sequence until mobile information terminal 100 displays a content list on the display screen.

In case where mobile information terminal 100 operates content stored in mobile information terminal 100 and content stored in HDD recorder 220, media server 230 and personal computer (PC) 240, first, input identifying section 110 identifies an input from the user. When input identifying section 101 identifies that the identification result of the input from the user is content search, command executing section 102 issues a device information acquisition request to AV devices 210 to 250 (step S1).

Device information acquiring section 104 of mobile information terminal 100 acquires device information of mobile information terminal 100 from terminal device information managing section 103 and device information from each AV device connected to the network, based on the device information request (step S2).

Device information determining section 151 in association list information controlling section 105 determines whether or not the acquired device information is server information and/or renderer information, and provides the server information to content information acquiring section 106. Further, device information determining section 151 provides the renderer information to association list information generating section 152 in association list information controlling section 105. Further, device information determining section 151 provides a device information determination completion report to command executing section 102, and command executing section 102 executes a content information acquisition request based on the device information determination completion report (step S3).

Content information acquiring section 106 of mobile information terminal 100 acquires content information of content stored in content managing section 110 of mobile information terminal 100 and content information of content stored in HDD recorder 220, media server 230 and personal computer (PC) 240 connected to the network, based on the server information and the content information acquisition request (step S4).

Then, content information acquiring section 106 provides the acquired content information to association list information generating section 152 in association list information controlling section 105. Further, content information acquiring section 106 provides a content information acquisition completion report to command executing section 102, and command executing section 102 executes the association list information generation request based on the content information acquisition completion report. Association list information generating section 152 generates association list information based on renderer information, content information and an association list information generation request (step S5).

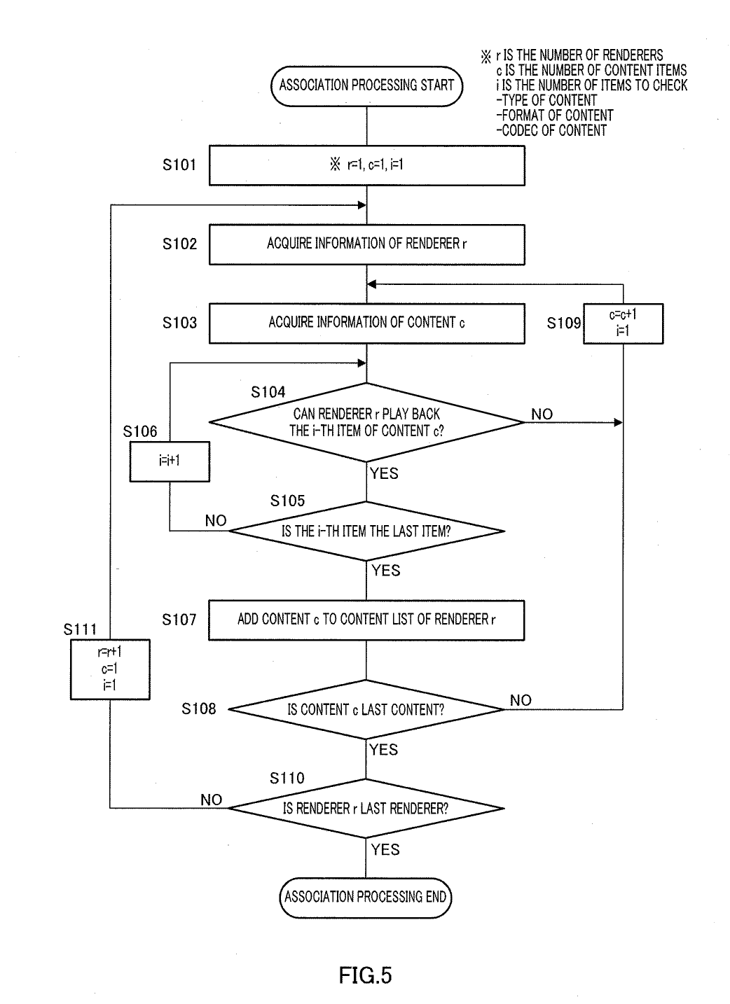

The above association processing for generating association list information that associates renderers with content that the renderers can play back, will be described later using the flowchart of FIG. 5.

Association list information managing section 153 in association list information controlling section 105 manages association list information generated in association list information generating section 152. Association list information managing section 153 provides the generated association list information to display processing section 109, so that display processing section 109 displays this association list information (step S6).

To play back content in mobile information terminal 100, association list information displayed on the display screen needs to be switched to the association list information matching mobile information terminal 100. Therefore, input identifying section 101 identifies an input from the user, and, if input identifying section 101 identifies that the identification result is a renderer display switch request, command executing section 102 issues a renderer display switch request.

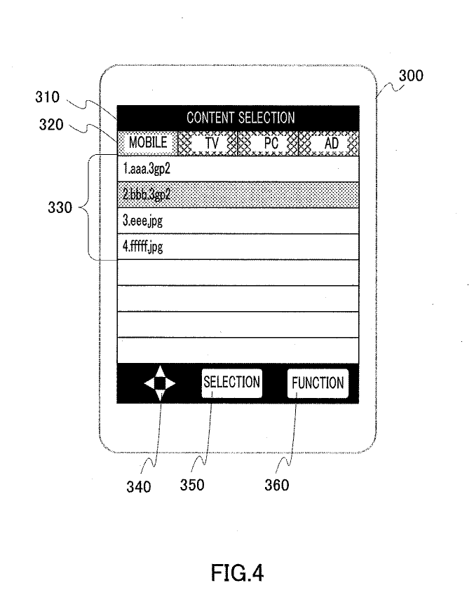

Association list information managing section 153 provides the association list information matching mobile information terminal 100, to display processing section 109, based on the renderer display switch request, and display processing section 109 outputs the association list information matching mobile information terminal 110, to display screen 300 shown in FIG. 4 (step S7).

FIG. 4 shows an example of a screen display of association list information. In FIG. 4, display screen 300 of display processing section 109 displays content selection screen 310, switch button 340 below content selection screen 310, selection button 350 and function button 360. Content selection screen 310 displays tabs 320 of renderers that mobile information terminal 100 can support, based on the association list information, and list 330 of content that each renderer can play back. With the example of FIG. 4, tabs 320 of renderers display “mobile” in case where mobile information terminal apparatus 100 is a mobile telephone, “TV” for digital television (TV) 250, “PC” for personal computer (PC) 240 and “AD” for audio device (AD) 210. “Mobile” is selected as tab 320 of a renderer, and therefore list 330 of content that can be played back on a per renderer basis displays a list of content that “mobile” can play back. Although the renderer is “mobile” with FIG. 4, when the renderer is switched by switch button 340, a display automatically switches to the list of content that the renderer after the switching can play back. Note that following Embodiments 2 and 3 describe that the content that is currently played back is played back by switching the renderer to another renderer, and Embodiment 4 describes later that content that needs to be played back and the renderer to perform playback processing are selected at the same time.

Back to the content playback sequence in FIG. 3, input identifying section 101 identifies an input from the user, and, if input identifying section 101 identifies that the identification result is a content cursor display switch request, command executing section 102 issues a content display switch request.

Association list information managing section 153 provides cursor display control information of content to which the user moved the cursor, based on the content cursor display switch request, and display processing section 109 displays the cursor on content to which the user moved the cursor (step S8).

Next, input identifying section 101 identifies an input from the user, and, if input identifying section 101 identifies that the identification result is a content operation control request, command executing section 102 issues a content operation control request.

Association list information managing section 153 specifies content information of the content selected by the user, from the index number indicating content in the displayed association list information and the displayed association list information, based on the content operation request, and further specifies renderer information selected by the user, from the specified content information and displayed association list information (step S9).

Further, association list information managing section 153 provides the specified content information and renderer information, and the content operation control request, to content operation controlling section 108.

Content operation controlling section 108 learns a request for playing back in mobile information terminal 100 the content stored in media server 230, based on the content information, renderer information, content operation control request and content operation information, and transmits the content operation control request to media server 230 through transmitting/receiving section 111 (step S10). Then, transmitting/receiving section 111 receives the content selected by the user, from media server 230 (step S11).

Transmitting/receiving section 111 provides video information of the received content to display processing section 109, and provides speech information of the content to speech processing section 107. Display processing section 109 and speech processing section 107 perform processing of playing back the content (step S12).

Further, display processing section 109 and/or speech processing section 107 perform processing of playing back the content and generate content operation information at the same time (step S12).

The above content operation control request is not limited to a playback processing request, and also includes a processing request for stop processing, pause processing, fast forward and rewind. Further, the content operation information includes, for example, playback time information of the content that is played back and content storage location information.

FIG. 5 is a flowchart for generating association list information that associates renderers with content that the renderers can play back. This is a detailed flowchart of association list information generation processing in step S5 of the content playback sequence in FIG. 3. This flowchart is executed by the CPU forming association list information controlling section 105 as association processing.

After the association processing starts, in step S101, the variable “r” indicating the number of renderers (hereinafter renderer number “r”), the variable “c” indicating the number of content items (hereinafter content number “c”) and the variable i indicating a check item number (hereinafter check item number “i”) are initialized. The items include the types of content, formats of content and codecs of content.

In step S102, the render information of renderer number r is acquired. In step S103, the content information of content number c is acquired.

After step S104, the type of content that a renderer can play back is checked based on the acquired renderer information and content information. That is, whether renderer number r can play back the i-th item of content c is determined in step S104, and, if renderer number r can play back the i-th item, whether or not the i-th item is the last item is determined in step S105.

If the i-th item is not the last item, the check item number is incremented in step S106 (i=i+1), the step returns to step S104. The format of content, which is the next check item, is compared in step S104.

If the i-th item is the last item in above step S105, content number c is added to the content list of renderer number r in step S107.

Whether or not content number c is the last content is determined in step S108. If content number c is not the last content or if renderer number r cannot play back the i-th item of content number c in above step S104, content number c is incremented in step S109 (c=c+1) and the check item number i is initialized (i=1) to return to step S103.

If content number c is the last content in above step S108, whether or not renderer number r is the last renderer is determined in step S110. If renderer number r is not the last renderer, renderer number r is incremented in step S111 (r=r+1) and content number c and check item number i are initialized (c=1 and i=1) to return to step S102. If renderer number r is the last renderer in above step S110, the flow is finished based on the decision that association processing is finished.

In this way, if the type of content can be played back by the renderer, the check item number i is incremented (step S106), the format of content, which is the next check item, is checked (step S104). As a result of a check, if the format can be played back by the renderer, the check item number i is incremented (step S106), and the codec of content, which is the next check item, is checked (step S104). As a result of a check, if the codec support playback by the renderer, the check of all check items is completed and it is possible to decide that the renderer can play back the content (step S105), and, consequently, the content is added to the list of content that the renderer can play back (step S107), content number c is incremented (step S109) and the same processing is performed to determine whether the renderer can play back the next content (c+1).

Further, if it is decided that the renderer cannot play back content as the result of comparison, the content number is incremented (step S109) and whether or not the renderer can play back the next content is determined. If it is decided that check processing of all content is executed for renderer number r (step S108), generation of association list information for renderer number r is completed, renderer number r is incremented, content number c and check item number i are initialized (step S111), and the same check processing is performed for the next renderer (r+1).

If it is decided that check of each check item of all content is completed for all renderers (step S110), association list generation processing is finished.

The check items in renderer information and content information are not limited to types of content that renderers can play back, formats of content and codecs of content, and other items of information may be used as check items.

As explained above in detail, according to the present embodiment, mobile information terminal 100 has: device information acquiring section 104 that acquires device information of mobile information terminal 100 and device information of devices connected to the network; content information acquiring section 106 that acquires content information of content stored in mobile information terminal 100 and content information of content stored in servers connected to the network; association list information controlling section 105 that generates and manages association list information which associates renderers with content that the renderers can play back, based on the acquired renderer information and content information; display processing section 109 that outputs the association list information to the display screen; and content operation controlling section 108 that controls content operations based on content information and device information selected from the association list information, a content operation control request and content operation information, so that, only by, in mobile information terminal 100, utilizing association list information which displays only content that can be played back and selecting content from association list information, the user can play back the selected content by mobile information terminal 100 without becoming aware of where the content is stored. By, for example, displaying association list information which associates renderers and content that the renderers can play back, on a per renderer basis as shown in FIG. 4, it is possible to display a content list that does not make the user feel inconvenient to operate content.

The advantage of the present embodiment will be explained below.

First, the advantage with respect to the problem with prior art will be explained.

The apparatus disclosed in Patent Document 1 does not take into account the content outputting apparatus (i.e. renderer) side, and the apparatus disclosed in Patent Document 2 only displays content collectively. By contrast with this, with the present embodiment, content that the renderers can play back are displayed, and consequently, it is possible to output any selected content from the selected renderer. Further, only content that a renderer can play back is displayed on a per renderer basis, so that it is possible to reduce the number of content items to display.

Moreover, the present embodiment provides the following excellent advantage regarding operability in particular. That is, (1) it is possible to select content that the user wants to play back and a renderer to perform playback processing at the same time. By displaying renderers by tabs and displaying content that can be played back, on a per renderer basis, a renderer and content can be selected, so that it is possible to overcome inconvenience of selecting content in conventional art of “selecting a server, selecting a renderer next and then selecting content.” (2) It is possible to output the content in mobile information terminal 100. Not only content in the server can be played back by the selected server, but also content in mobile information terminal 100 can be played back in the same UI (User Interface) by the renderer. (3) It is easy to switch renderers. In case where the content that is currently played back needs to be played back by switching the renderer to another renderer, it is readily possible to switch renderers.

Next, the advantage unique to the present embodiment will be explained in detail.

It is possible to identify information received as input from the user, and execute a command based on the identification result. Further, it becomes possible to acquire device information of mobile information terminal 100 and devices connected to the network based on the command, and acquire content information of content held in mobile information terminal 100 and the devices connected to the network. Furthermore, it becomes possible to generate association list information which associates renderers with content that the renderers can output, based on the acquired device information and content information, and output the association list information to the display screen. Still further, it becomes possible to acquire the content information selected from the association list information outputted to the display screen, and relevant device information, and operate the selected content by the selected renderer based on a content operation control request.

It is also possible to output content operation information, and moving image information or still image information of content provided from content operation controlling section 108, to the display screen, and outputs content speech information provided from content operation controlling section 108.

It is also possible to transmit and receive selected content through a network, and receive content operation information from a server and/or renderer through the network.

Command executing section 102 outputs a content information acquisition request to content information acquiring section 106 based on a device information determination completion report from association list information controlling section 105, and consequently can request for content information acquisition based on the device information determination completion report.

Command executing section 102 outputs an association list information generation request to association list information controlling section 105 based on the content information acquisition completion report from content information acquiring section 106, and consequently can request for association list information generation based on the content information acquisition completion report.

Content information acquiring section 106 outputs a content information acquisition request based on the content information acquisition request from command executing section 102 and the server information from association list information controlling section 105, and consequently, can request for content information acquisition based on the content information acquisition request and server information.

Association list information controlling section 105 has device information determining section 151 that determines that device information acquired in the device information acquiring section is server information and/or renderer information, and consequently can determine that device information of mobile information terminal 100 and device information of devices connected to the network is server information and/or renderer information.

Association list information controlling section 105 has association list information generating section 152 that generates association list information which associates renderers with content that the renderers can play back, on a per renderer basis, based on an association list information generation request from command executing section 102, renderer information which is the determination result in device information determining section 151 and content information acquired in content information acquiring section 106, and consequently can generate the association list information which associates renderers with content that the renderers can play back, based on the association list information generation request, acquired renderer information and acquired content information.

Association list information controlling section 105 has association list information managing section 153 that manages association list information generated in association list information generating section 152 and provides association list information to display processing section 109, and consequently can manage the generated association list information and provide the association list information to display processing section 109.

Association list information managing section 153 provides association list information matching a renderer to switch to, to display processing section 109 based on a renderer display switch request from command executing section 102, and consequently can acquire association list information matching a renderer to switch to, based on the list display switch request and provide association list information matching the renderer to switch to, to display processing section 109.

Association list information managing section 153 provides cursor display control information for content to switch to, to display processing section 109 based on a content cursor display switch request from command executing section 102, and consequently can provide cursor display control information for switching a display of a cursor to content to switch to, based on the content cursor display switch request.

Association list information managing section 153 provides content information and renderer information related to the selected content, and a content operation control request from command executing section 102, to content operation controlling section 108 based on a content operation control request from command executing section 102, and consequently can specify content and a renderer selected by the user and provide content information of the specified content, renderer information of the renderer and a content operation control request, to content operation controlling section 108.

Content managing section 110 provides content to content operation controlling section 108 based on a content acquisition request from content operation controlling section 108, and consequently can acquire content managed by content managing section 110 and provide the content to content operation controlling section 108.

Content operation controlling section 108 is configured to request for content acquisition to content managing section 110 based on content information and renderer information selected in association list information managing section 153, a content operation control request provided from command executing section 102 through association list information managing section 153 and content operation information managed in the content operation controlling section, acquire content from content managing section 110 and provide the acquired content to display processing section 109 and/or speech processing section 107, and consequently can acquire content from content managing section 110 based on the content information, renderer information, content operation control request and content operation information, and output the acquired content through display processing section 109 and speech processing section 107.

Content operation controlling section 108 is configured to request for content acquisition to content managing section 110 based on content information and renderer information selected in association list information managing section 153, a content operation control request provided from command executing section 102 through association list information managing section 153 and content operation information managed in content operation controlling section 108, acquire content from content managing section 110 and provide the acquired content and a content operation control request to a selected renderer through transmitting/receiving section 111, and consequently can acquire content from content managing section 110 based on the content information, renderer information, content operation control request and content operation information and transmit the acquired content and content operation control request to the selected renderer through the network.

Content operation controlling section 108 is configured to request for content operation control to the server through transmitting/receiving section 111, based on content information and renderer information selected in association list information managing section 153, a content operation control request provided from command executing section 102 through association list information managing section 153 and content operation information managed in content operation controlling section 108, acquire content stored in the server through transmitting/receiving section 111 and provide the acquired content to display processing section 109 and/or speech processing section 107, and consequently can acquire content from the server connected to the network, based on the content information, renderer information, content operation control request and content operation information and provide the acquired content to display processing section 109 and/or speech processing section 107.

Content operation controlling section 108 is configured to provide a content operation control request to the server and/or renderer through transmitting/receiving section 111, such that content stored in the server is provided to the renderer based on content information and renderer information selected in association list information managing section 153, a content operation control request provided from command executing section 102 through the association list information managing section and content operation information managed in content operation controlling section 108, and consequently can operate the content, server and renderer such that content stored in the server connected to the network is provided to the renderer connected to the network based on the content information, renderer information, content operation control request and content operation information.

Content operation controlling section 108 generates and manages content operation information based on the content operation control request and acquires and manages content operation information in response to the content operation control request from the server and/or renderer connected to the network, and consequently can generate and manage content operation information based on the content operation control request. Further, it is possible to acquire content operation information in response to the content operation control request from the server and/or renderer through the network based on a content operation control request.

Display processing section 109 performs processing of displaying a cursor on content in displayed association list information based on cursor display control information from association list information managing section 153, performs processing of displaying a device information acquisition status report based on device information acquisition status report information from device information acquiring section 104, performs processing of displaying a content information acquisition status report based on content information acquisition status report information from content information acquiring section 106 and performs processing of displaying content based on content provided from content operation controlling section 108, and consequently can move cursor display on the content of association list information displayed on the screen. Further, it is possible to make the screen display transition to a screen in which device information is currently acquired, based on device information acquisition status report information. Furthermore, it is possible to make the screen display transition to the screen in which content information is currently acquired, based on content information acquisition status report information. Still further, it is possible to output content provided from the content operation controlling section.

Transmitting/receiving section 111 provides server information and renderer information received through the network, to device information acquiring section 104, provides content information received through the network, to content information acquiring section 106, transmits content and/or a content operation control request to the server and/or renderer through the network and receives content and/or content operation information from the server and/or renderer through the network to provide the content and/or content operation information to content operation controlling section 108, and consequently can acquire device information from the server and/or renderer connected to the network. Further, it is possible to acquire content information from servers connected to the network. Furthermore, it is possible to transmit a content operation control request to the servers and renderers connected to the network, and receive content operation information matching the content operation control request. Still further, it is possible to transmit content and a content operation control request to the servers and renderers connected to the network, and receive content operation information matching the content operation control request.

### Embodiment 2

Embodiment 2 is an example of a case where content stored in HDD recorder 220 is played back by digital television (TV) 250 connected to the network.

The configuration of the home network forming a mobile information terminal that has a content managing apparatus according to Embodiment 2 is the same as in FIG. 1 and FIG. 2, and explanation thereof will be omitted.

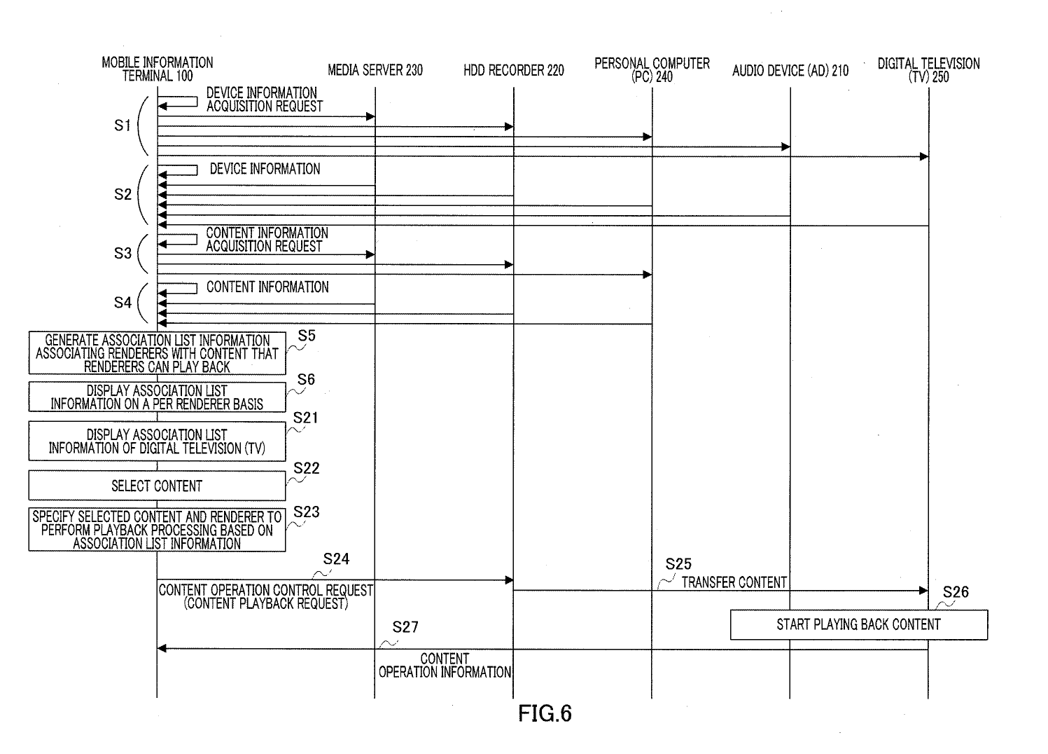

FIG. 6 is a content playback sequence diagram of a home network formed with the mobile information terminal and AV devices according to Embodiment 2 of the present invention. The same processings as in the sequence of FIG. 3 will be assigned the same step numbers, and explanation thereof will be omitted.

To play back content in digital television (TV) 250, association list information displayed on the display screen of mobile information terminal 100 is switched to association list information matching digital television (TV) 250. Therefore, input identifying section 101 identifies an input from the user, and, if input identifying section 101 identifies that the identification result is a renderer display switch request, command executing section 102 issues a renderer display switch request.

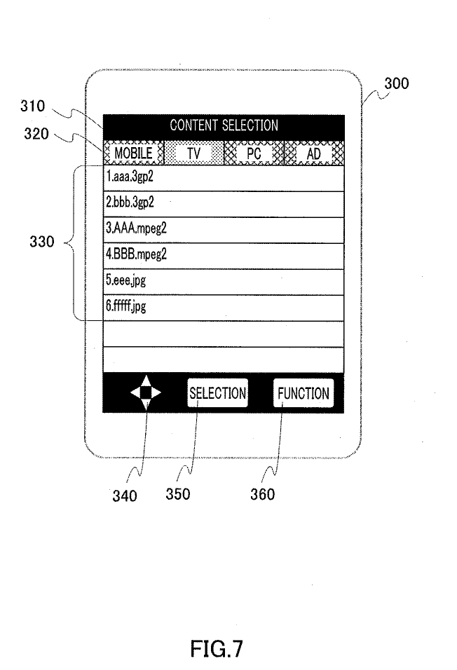

Association list information managing section 153 provides the association list information matching digital television (TV) 250, to display processing section 109 based on the renderer display switch request, and display processing section 109 outputs the association list information matching digital television (TV) 250, to display screen 300 shown in FIG. 7 (step S21).

FIG. 7 shows an example of a screen display of association list information. The same parts as in FIG. 4 are assigned the same reference numerals. With the example of FIG. 7, “TV” for digital television (TV) 250 is selected as tab 320 of the renderer, and therefore list 330 of content that can be played back on a per renderer basis displays the list of content that “TV” can play back.

Back to the content playback sequence of FIG. 6, if the user selects content that the user wants to play back (step S22), content operation controlling section 108 learns the request for playing back the content stored in HDD recorder 220 by digital television (TV) 250, based on the selected content information and renderer information, content operation control request and content operation information (step S23).

Then, content operation controlling section 108 transmits the content operation control request to HDD recorder 220 through transmitting/receiving section 111 (step S24).

HDD recorder 220 transfers the content selected by the user, to digital television (TV) 250 based on the content operation control request (step S25).

Digital television (TV) 250 plays back the received content (step S26). Further, digital television (TV) 250 transmits content operation information to mobile information terminal 100 (step S27).

As described above, according to the present embodiment, only by utilizing association list information which displays only content that digital television (TV) 250 can play back and selecting content from the association list information, the user can play back the selected content by digital television (TV) 250 without becoming aware of where the content is stored. Further, digital television (TV) 250 transmits content operation information to mobile information terminal 100, so that mobile information terminal 100 can control content operations.

### Embodiment 3

Embodiment 3 is an example of a case where personal computer (PC) 240 plays back content stored in mobile information terminal 100.

The configuration of a home network forming a mobile information terminal that has a content managing apparatus according to Embodiment 3 is the same as in FIG. 1 and FIG. 2, and therefore explanation thereof will be omitted.

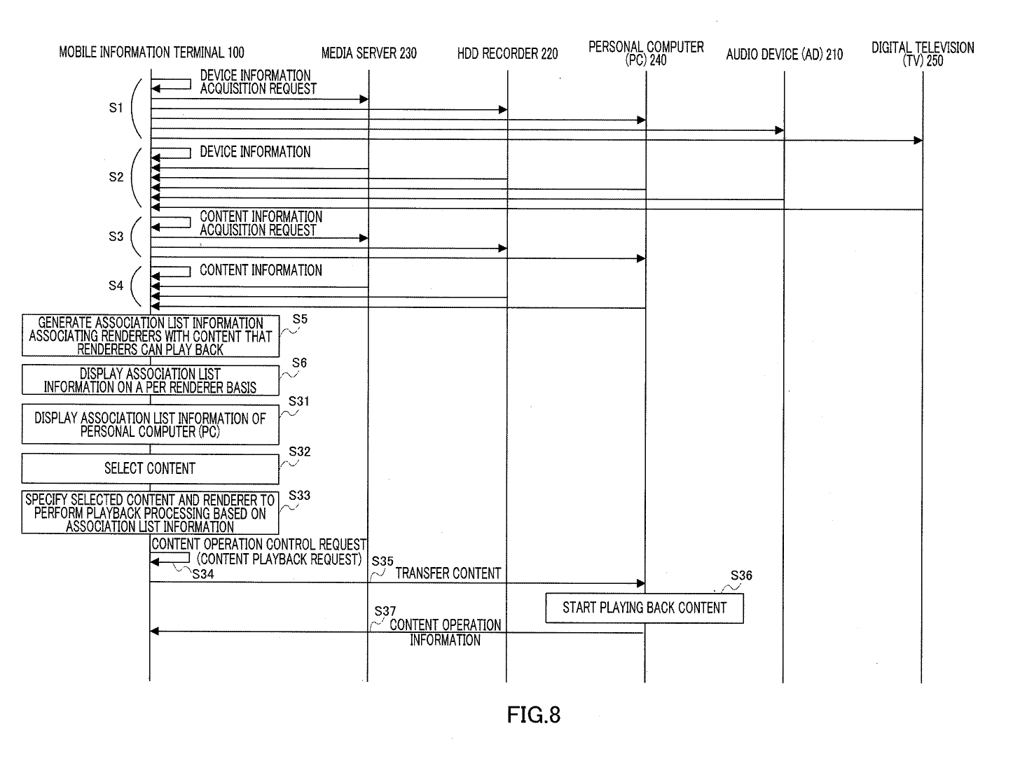

FIG. 8 is a content playback sequence diagram of the mobile information terminal and the home network formed with AV devices according to Embodiment 3 of the present invention. The same processings as in the sequence of FIG. 3 will be assigned the same step numbers and explanation thereof will be omitted.

To play back content in personal computer (PC) 240, association list information displayed on the display screen of mobile information terminal 100 is switched to association list information matching personal computer (PC) 240. Therefore, input identifying section 101 identifies an input from the user, and, if input identifying section 101 identifies that the identification result is a renderer display switch request, command executing section 102 issues the renderer display switch request.

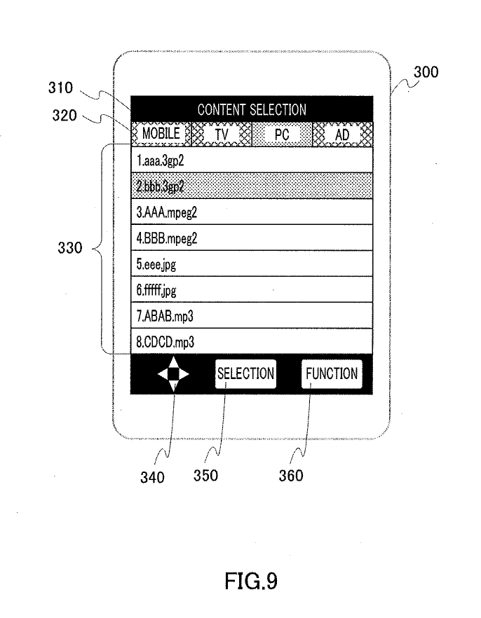

Association list information managing section 153 provides the association list information matching personal computer (PC) 240, to display processing section 109, based on the renderer display switch request, and display processing section 109 outputs the association list information matching personal computer (PC) 240, to display screen 300 shown in FIG. 9 (step S31).

FIG. 9 shows an example of a display screen of association list information. The same parts as in FIG. 4 are assigned the same reference numerals. With the example of FIG. 9, “PC” for personal computer (PC) 240 is selected as tab 320 of a renderer, and therefore list 330 of content that can be played back on a per renderer basis displays a list of content that “PC” can play back. Personal computer (PC) 240 has higher content playback performance, and therefore there are many content that “PC” can play back. With this example, all content of renderers including “TV” for digital television (TV) 250 and “mobile” in case where mobile information terminal 100 is a mobile telephone, can be played back, and content selection screen 310 displays a list of content that “PC” can play back. Further, the list that cannot be displayed on content selection screen 310 can be displayed by operating a key to scroll the list.

Back to the content playback sequence of FIG. 8, if the user selects content that the user wants to play back (step S32), content operation controlling section 108 learns a request for playing back content stored in mobile information terminal 100 by personal computer (PC) 240, based on the selected content information and renderer information, content operation control request and content operation information (step S33).

Then, content operation controlling section 108 outputs a content acquisition request of content selected by the user, to content managing section 110 (step S34), and content managing section 110 provides the selected content to content operation controlling section 108 based on the content acquisition request.

Content operation controlling section 108 transmits the content and content operation control request acquired through transmitting/receiving section 111, to personal computer (PC) 240 (step S35), and personal computer (PC) 240 plays back the received content based on the content operation control request (step S36).

Personal computer (PC) 240 transmits content operation information to mobile information terminal 100 (step S37).

As described above, according to the present embodiment, only by utilizing association list information which displays only content that personal computer (PC) 240 can play back and selecting content from the association list information, the user can play back the selected content by personal computer (PC) 240 without becoming aware of where the content is stored. Further, by transmitting content operation information from personal computer (PC) 240 to mobile information terminal 100, mobile information terminal 100 can control playback of content.

### Embodiment 4

Embodiment 4 is an example of a case where, while personal computer (PC) 240 plays back content stored in mobile information terminal 100, the content continues being played back by switching the renderer to mobile information terminal 100.

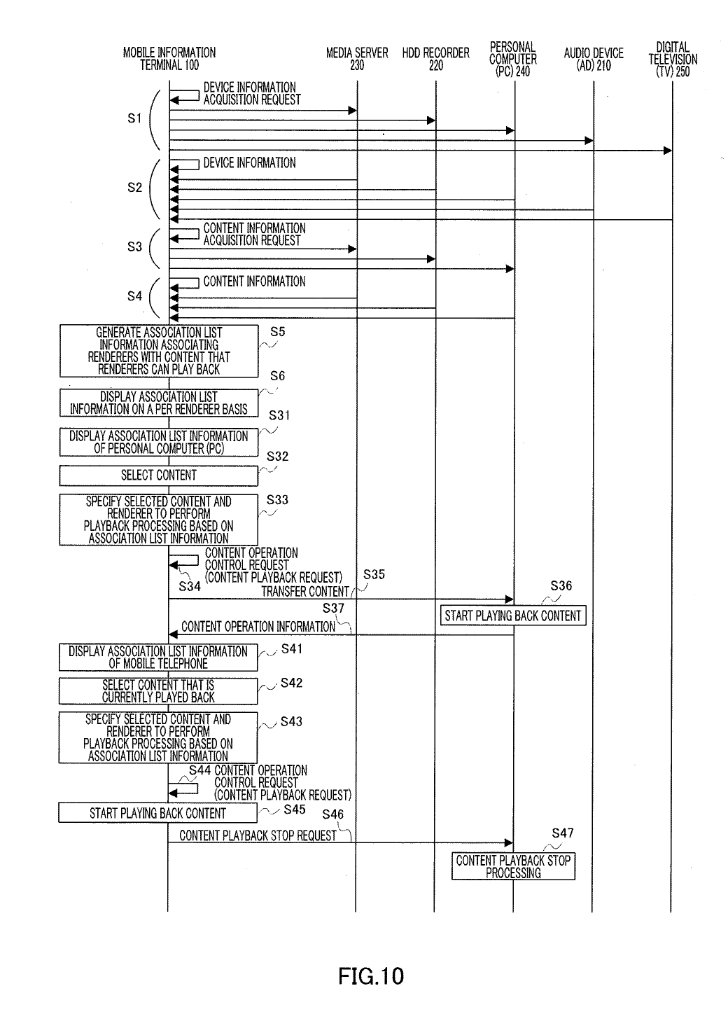

FIG. 10 is a content playback sequence diagram of a mobile information terminal that has a content managing apparatus and a home network formed with AV devices according to Embodiment 4 of the present invention. The same processings as in the sequence of FIG. 8 will be assigned the same step numbers, and explanation thereof will be omitted.

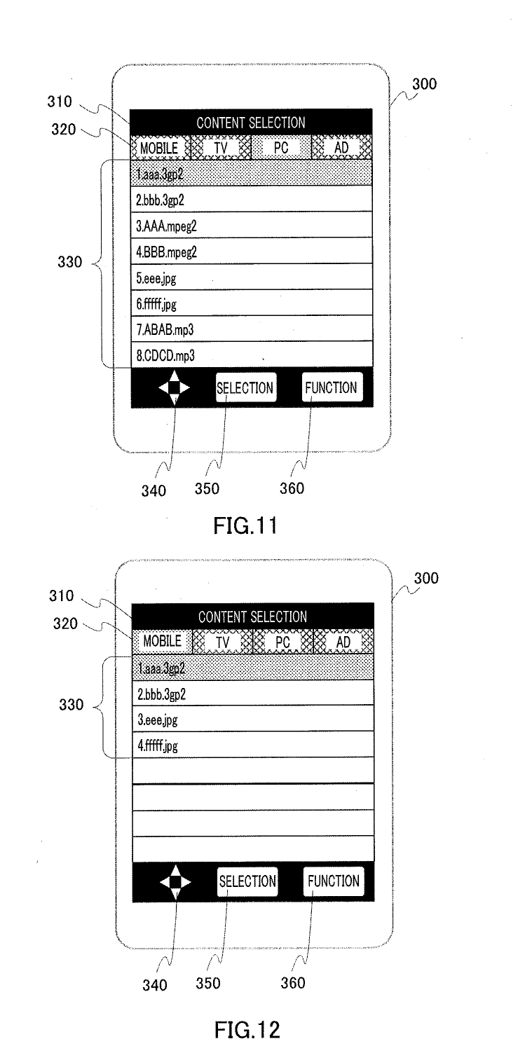

Further, FIG. 11 and FIG. 12 show examples of a display screen of association list information. The same parts as in FIG. 4 will be assigned the same reference numerals. With the example of FIG. 11, “PC” for personal computer (PC) 240 is selected as tab 320 of a renderer, and therefore list 330 of content that can be played back on a per renderer basis displays a list of content that “PC” can play back. FIG. 12 shows an example of a screen display for association list information in case where, while personal computer (PC) 240 plays back content, the content continues being played back by switching the renderer to mobile information terminal 100. As shown in FIG. 12, by switching the renderer, “mobile” is selected and list 330 of content that can be played back on a per renderer basis displays a list of content that “mobile” can play back.

If input identifying section 101 receives an input from the user while personal computer (PC) 240 plays back content stored in mobile information terminal 100, input identifying section 101 identifies the input and, if input identifying section 101 identifies that the identification result is a renderer display switch request, command executing section 102 issues a renderer display switch request.

Association list information managing section 153 provides association list information matching mobile information terminal 100, to display processing section 109, based on the renderer display switch request, and display processing section 109 outputs the association list information matching mobile information terminal 100, to display screen 300 shown in FIG. 12 (step S41).

If the user selects content that the user wants to play back (step S42), content operation controlling section 108 learns a request for continuing playing back the content that is stored in mobile information terminal 100 and that is currently played back, by mobile information terminal 100 based on the selected content information and renderer information, content operation control request and content operation information (step S43).

Then, content operation controlling section 108 outputs a content acquisition request of the selected content, to content managing section 110 (step S44).

Content operation controlling section 108 provides video information that continues from the content that is currently played back by personal computer (PC) 240, to display processing section 109 based on the content acquired from content managing section 110, content operation control request and content operation information, and provides speech information to speech processing section 107. In this way, mobile information terminal 100 plays back content that continues from content played back by personal computer (PC) 240 (step S45). Further, mobile information terminal 100 transmits a playback stop request of content, to personal computer (PC) 240 (step S46), and personal computer (PC) 240 that receives the playback stop request performs processing of stopping playing back the content (step S47).

As described above, according to the present embodiment, while personal computer (PC) 240 plays back content, it is possible to continue playing back content by switching the renderer to mobile information terminal 100.

The above explanation is an illustration of preferred embodiments of the present invention, and the scope of the present invention is not limited to these. For example, the target to which a renderer is switched to continue playing back content is not limited to the mobile information terminal, and another renderer that can play back the content and that is connected to the network may continue playing back the content. For example, renderers may be DVD recorders that store content, LAN discs, TVs that output content, component audio systems and printers.

Content operation information may be generated upon a content operation control request and acquired through the network, or may be generated on a regular basis and acquired through the network.

Association list information display is not limited to the order of tabs of renderers shown in the drawings, and the association list information may be displayed according to setting information for setting the order the renderer information is acquired, the alphabetical order of renderer names or the order the renderers are displayed and other display orders are possible.

Default association list information may display association list information of a mobile information terminal or another renderer.

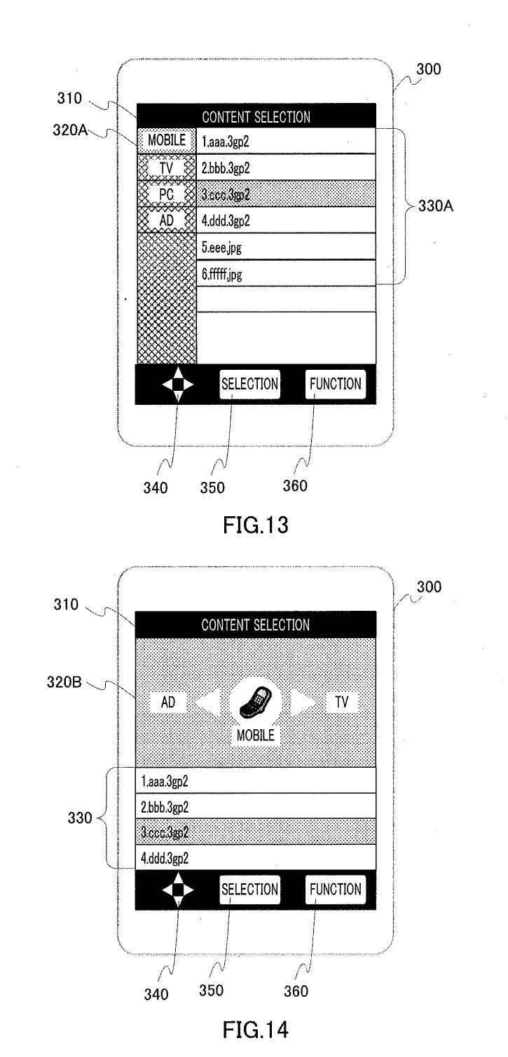

The display mode for association list information is not limited to the display modes shown in FIG. 4, FIG. 7, FIG. 9, FIG. 11 and FIG. 12, any display mode is possible as long as a list is displayed such that renderers and content that the renderers can play back are displayed in association. Hereinafter, other display modes for displaying association lists will be explained with reference to FIG. 13 to FIG. 16.

FIG. 13 to FIG. 16 show examples of a screen display of association list information. The same parts as in FIG. 4 will be assigned the same reference numerals.

As shown in FIG. 13, a display mode is possible where tabs 320A of renderers that can play back content are displayed vertically on the left side and list 330A of content that the renderers can play back is displayed on the right side based on association list information.

As shown in FIG. 14, a display mode is possible where tab 320 of a renderer that can play back content may be displayed as an icon based on association list information.

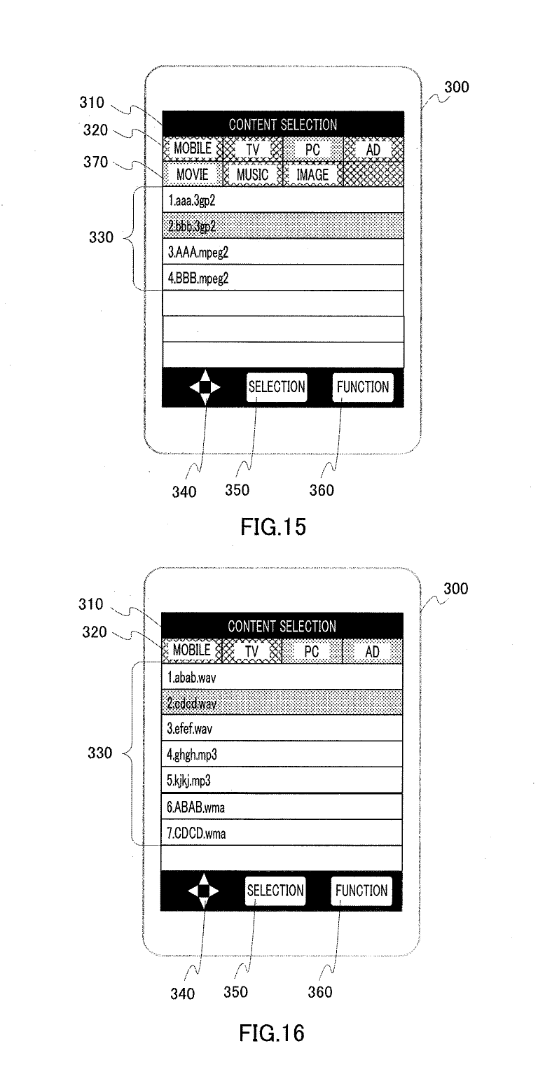

As shown in FIG. 15, a configuration is possible where, in addition to tabs 320 of renderers that can play back content, tabs 370 related to types of content may be provided based on association list information. Tabs 370 related to types of content include, for example, movie, music and images, and may be displayed by symbol marks.

With Embodiments 1 to 4, it is possible to display content that can be played back on a per renderer basis as shown in above FIG. 4, and play back content that is currently played back, by switching the renderer to another renderer (see above FIG. 9). In this case, a configuration is possible where, if content that is currently played back needs to continue being played back by switching the renderer to another renderer, content that is currently played back is displayed separately from renderers that cannot play back the content.

As is clear from comparison between above FIG. 9 and FIG. 16, tabs 320 of renderers that can play back content may be configured such that a tab display for the renderer “AD” which can continue playing back content that the renderer “PC” currently plays back, may be distinguished from renderers “mobile” and “TV” that cannot play back the content (that is, distinguished by active/non-active display and distinguished by a background color) and displayed.

Although the display modes for content names in the association lists shown in above FIG. 4, FIG. 7, FIG. 9 and FIG. 11 to FIG. 16 show a display including extensions, display modes are possible where only content names not including extensions are displayed.

Although names “content managing apparatus” and “mobile information terminal” are used with the present embodiment for ease of explanation, “content providing apparatus,” “content system playback system,” “electric device” and “renderer-specific content displaying method” are possible.

Furthermore, any type, number and connecting method of components such as the network, transmitting/receiving section and content operation controlling section forming the above mobile information terminal, servers and AV devices are possible. The home network is not limited to the DLNA network.

The above-explained content playback method is realized by the program for functioning this content playback method. This program is stored in a computer readable recording medium.

### INDUSTRIAL APPLICABILITY

The content managing apparatus and content playback method according to the present invention can be developed to a terminal apparatus and system that display a renderer-specific content list. By displaying association list information on a per renderer basis, it is possible to display a content list that does not make the user feel inconvenient to operate content and, consequently, the present invention is useful as a mobile information terminal that displays a list of content stored in servers through the network, in particular, a device coordinating system in a home network.

1. A content managing apparatus comprising:
a device information acquiring section that acquires server information and content playback device information held by a device connected to a network;
a content information acquiring section that acquires content information of content stored in the device;
an association list information controlling section that generates and manages association list information which associates content playback devices with content that the content playback devices can output, based on the acquired content playback device information and the content information;
a display processing section that outputs the association list information to a display screen; and
a content operation controlling section that controls a content operation based on content information and content playback device information selected from the association list information, a content operation control request and content operation information.

2. The content managing apparatus according to claim 1, further comprising:
an input identifying section that identifies input information; and
a command executing section that executes a command based on an identification result in the input identifying section, wherein;
the device information acquiring section acquires the server information and the content playback device information based on a device information acquisition request from the command executing section; and
the content information acquiring section acquires the content information based on a content information acquisition request from the command executing section.

3. The content managing apparatus according to claim 2, further comprising:
a terminal device information managing section that manages the server information and the content playback device information;
a content managing section that manages content that is held; and
a transmitting/receiving section that transmits the device information acquisition request, the content information acquisition request and the content operation control request, to a content playback device through a network, and that receives the content playback device information, the content information and content operation information from the content playback device.

4. The content managing apparatus according to claim 3, further comprising a speech processing section that outputs speech information of content provided from the content operation controlling section, wherein;
the display processing section outputs moving image information, still image information and the content operation information of content provided from the content operation controlling section, to a display screen; and
the transmitting/receiving section transmits and receives content.

5. The content managing apparatus according to claim 1, wherein the device information acquiring section acquires the server information and the content playback device information as device information.

6. The content managing apparatus according to claim 2, wherein the command executing section outputs the content information acquisition request to the content information acquiring section based on a device information determination completion report from the association list information controlling section.

7. The content managing apparatus according to claim 2, wherein the command executing section outputs an association list information generation request to the association list information controlling section based on a content information acquisition completion report from the content information acquiring section.

8. The content managing apparatus according to claim 2, wherein the content information acquiring section outputs the content information acquisition request based on the content information acquisition request from the command executing section and the server information from the association list information controlling section.

9. The content managing apparatus according to claim 1, wherein the association list information controlling section determines that device information acquired in the device information acquiring section is the server information and the content playback device information.

10. The content managing apparatus according to claim 9, further comprising:
an input identifying section that identifies input information; and
a command executing section that executes a command based on an identification result in the input identifying section, wherein the association list information controlling section generates association list information which associates content playback devices with content that the content playback devices can play back, on a per content playback device basis, based on an association list information generation request from the command executing section, the content playback device information determined in the association list information controlling section and content information acquired in the content information acquiring section.

11. The content managing apparatus according to claim 10, wherein the association list information controlling section generates and manages the association list information, and, in addition, provides the association list information to the display processing section.

12. The content managing apparatus according to claim 11, wherein the association list information controlling section provides association list information matching a content playback device to switch to, to the display processing section based on a content playback device display switch request from the command executing section.

13. The content managing apparatus according to claim 11, wherein the association list information controlling section provides cursor display control information for content to switch to, to the display processing section based on a content cursor display switch request from the command executing section.

14. The content managing apparatus according to claim 11, wherein the association list information controlling section provides content information and content playback device information related to selected content, and a content operation control request from the command executing section, to the content operation controlling section based on a content operation control request from the command executing section.

15. The content managing apparatus according to claim 3, wherein the content managing section provides content to the content operation controlling section based on a content acquisition request from the content operation controlling section.

16. The content managing apparatus according to claim 11, further comprising:
a terminal device information managing section that manages the server information and the content playback device information;
a content managing section that manages content that is held; and
a transmitting/receiving section that transmits a device information acquisition request, a content information acquisition request and a content operation control request, to a content playback device through a network, and that receives the content playback device information, the content information and the content operation information from the content playback device, wherein the content operation controlling section outputs a content acquisition request to the content managing section based on content information and content playback device information selected by the association list information controlling section, the content operation control request provided from the command executing section through the association list information controlling section and the content operation information managed in the content operation controlling section, acquires content from the content managing section and provides the acquired content and the content operation control request to the selected content playback device through the transmitting/receiving section.

17. The content managing apparatus according to claim 11, further comprising a transmitting/receiving section that transmits a device information acquisition request, a content information acquisition request and a content operation control request, to a content playback device through a network, and that receives the content playback device information, the content information and the content operation information from the content playback device, wherein the content operation controlling section provides the content operation control request to a server and a content playback device through the transmitting/receiving section, such that content stored in the server is provided to the content playback device based on content information and content playback device information selected by the association list information controlling section, the content operation control request provided from the command executing section through the association list information controlling section and the content operation information that is managed.

18. The content managing apparatus according to claim 3, wherein the content operation controlling section generates and manages the content operation information based on the content operation control request, and acquires and manages the content operation control information in response to the content operation control request, from a server and the content playback device connected to a network, through the transmitting/receiving section.

19. The content managing apparatus according to claim 11, wherein the display processing section performs processing of displaying a cursor on content in displayed association list information based on cursor display control information from the association list information controlling section, performs processing of displaying a device information acquisition status report based on device information acquisition status report information from the device information acquiring section, performs processing of displaying a content information acquisition status report based on content information acquisition status report information from the content information acquiring section and performs processing of displaying content based on content provided from the content operation controlling section.

20. The content managing apparatus according to claim 3, wherein the transmitting/receiving section provides server information and content playback device information received through a network, to the device information acquiring section, provides content information received through the network to the content information acquiring section, further transmits content and a content operation control request to a server and the content playback device through the network and receives content and the content operation information from the server and the content playback device through the network to provide the content and the content operation information to the content operation controlling section.

21. A content playback method in a content managing apparatus, the content playback method comprising the steps of:
acquiring server information and content playback device information of a device connected to the network;
acquiring content information of content stored in a server connected to the network;
generating and managing association list information which associates content playback devices with content that the content playback devices can play back, based on the acquired content device information and content information;
outputting the association list information to a display screen; and
controlling a content operation based on content information and content playback device information selected from the association list information, a content operation control request and content operation information.

22. A program causing a computer to execute the steps of:
acquiring server information and content playback device information of a device connected to the network;
acquiring content information of content stored in a server connected to the network;
generating and managing association list information which associates content playback devices with content that the content playback devices can play back, based on the acquired content device information and the content information;
outputting the association list information to a display screen; and
controlling a content operation based on content information and content playback device selected from the association list information, a content operation control request and content operation information.
